(19) United States
(12) Patent Application Publication
(10) Pub. No.: US 2016/0279517 A1
(43) Pub. Date: Sep. 29, 2016

(54) IMAGE IDENTIFICATION GAME

(71) Applicant: Walter Firth, Dayton, OH (US)

(72) Inventor: Walter Firth, Dayton, OH (US)

(21) Appl. No.: 15/074,366

(22) Filed: Mar. 18, 2016

Related U.S. Application Data
(60) Provisional application No. 62/137,270, filed on Mar. 24, 2015.

(51) Int. Cl. A63F 13/537; A63F 13/35

(52) U.S. Cl. CPC A63F 13/537; A63F 13/35

(57) ABSTRACT

The present invention is a system and method for playing an image guessing game between one or more players. Images are displayed as increasingly larger portions of a complete image until a player guesses the image or the full image is displayed. The system may comprise a plurality of computerized devices that communicates electronically over a wide area network such as the internet.

### CROSS-REFERENCE TO RELATED APPLICATION

This application claims the benefit of U.S. Provisional Patent Application No. 62/137,270 filed Mar. 24, 2015, the disclosure of which is hereby incorporated by reference as if restated in its entirety.

### TECHNICAL FIELD

Exemplary embodiments of the present invention relate generally to an image identification game.

### BACKGROUND AND SUMMARY OF THE INVENTION

Guessing games are well known in the art however, many such games rely on the provider of the game to also source the material to be guessed. In addition, in embodiments where the materials to be guessed are images, those images may be geographically distant from game players, requiring that the images be extremely well known. What is needed is a guessing game that enables players to choose categories of images to be guessed by other players. In addition, what is needed is a method of providing players hints or suggestions in the event that the players are having difficulty identifying the material to be guessed.

In embodiments of the present invention, a user may import photographs or other images to an electronic device such as, but not limited to, a smart phone or tablet computer from various sources. Once imported, the user may make adjustments to the viewable area of the image to display a smaller portion of the image in a display area of an electronic device. When satisfied with the displayed area, the user may save the image and continue to adjust and save images until the user is satisfied with the number and quality of images or until the image becomes distorted as the result of lack of available resolution. Hints and descriptions may be appended to the images during the saving process. Once completed, the collection of images, hints and descriptions may be referred to as a game piece.

In embodiments of the invention, the saved image may be displayed on the display of an electronic device where only a portion of the image is visible to a game participant. Game participants (users) may attempt to guess the partially displayed image. Participants may play the game individually or against other participants. In embodiments of the invention, one or more hints may also be provided for the participant to assist in their identification of the image. Certain embodiments of the invention may permit game participants to have multiple opportunities to identify the image. In embodiments of the invention, the participants may be provided with increasingly larger portions of an image if they are not able to identify the image from smaller portions. In embodiments of the invention, each smaller portion of the image is derived from the next larger version of the image. This may be similar to images one would see if they were “zooming out” using a telephoto camera lens.

### BRIEF DESCRIPTION OF THE DRAWINGS

In addition to the features mentioned above, other aspects of the present invention will be readily apparent from the following descriptions of the drawings and exemplary embodiments, wherein like reference numerals across the several views refer to identical or equivalent features, and wherein:

FIG. 1 is a block diagram illustrating an embodiment of the invention;

FIG. 2 is a flow chart of steps performed by a processor in an embodiment of the invention to create game pieces;

FIG. 3a is an illustration of a full view of an image from which a game piece may be created;

FIG. 3b illustrates a portion of the image of FIG. 3a;

FIG. 3c illustrates a portion of the image of FIG. 3b;

FIGS. 3d and 3e are illustrations of images with superimposed clues displayed;

FIGS. 4a and 4b are illustrations of example images and image portions;

FIG. 5 is a flow chart of the game piece creation in an embodiment of the invention;

FIG. 6 is a flow chart illustrating game play in an embodiment of the invention; and

FIG. 7 is an exemplary user interface of an embodiment of the invention.

### DETAILED DESCRIPTION OF EXEMPLARY EMBODIMENT(S)

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

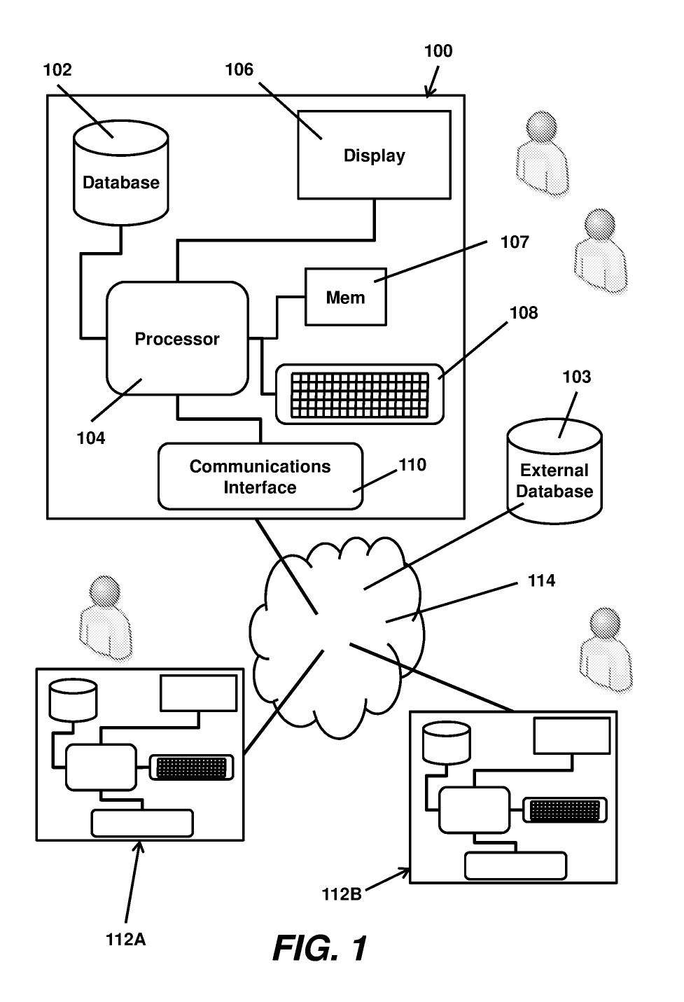

Embodiments of the present invention comprise an image guessing game that may allow one or more participants to view an image and respond with guesses as to what the image illustrates. As is illustrated in FIG. 1, a computerized device 100 may comprise an image database 102, a processor 104, a display device 106, and an input device 108, which may be, but is not limited to, a keyboard, mouse, track pad, microphone, camera, or touch screen. Embodiments of the invention may also have a communications interface 110 that allows the computerized device 100 to be in electronic communication with one or more additional computerized devices 112. In addition to the internal database 102, one or more external databases 103, cameras, copier/scanners, internet web sites, smart phones, and other sources of electronic images may also be used as sources of images used by the invention. As used herein, computerized devices may include, but are not limited to, bench top and desktop computers, laptop computers, tablet computers, video game systems, and smart phones. The computerized device 100 may further comprise a memory storage media 107 such as a hard drive, flash drive, random access memory, or the like. In exemplary embodiments, the internal database 102 may be located on the memory storage media 107. The memory storage media 107 may further comprise software instructions for operating the image guessing game and performing other functions on the computerized device 100.

In an embodiment of the invention, the premise of the guessing game is that one or more users may be presented with an image and attempt to identify the subject of the image by entering a guess as to that subject into an embodiment of the invention. In certain embodiments of the invention, participants may have multiple opportunities to respond with such guesses. Each opportunity may present a slightly larger portion of the image to the participants. In addition to the image, participants may be provided with a subject or category within which the image may reside. Certain embodiments of the invention may also include written or audio hints to assist the participant in responding with a correct guess.

### Selection and Cropping of Images

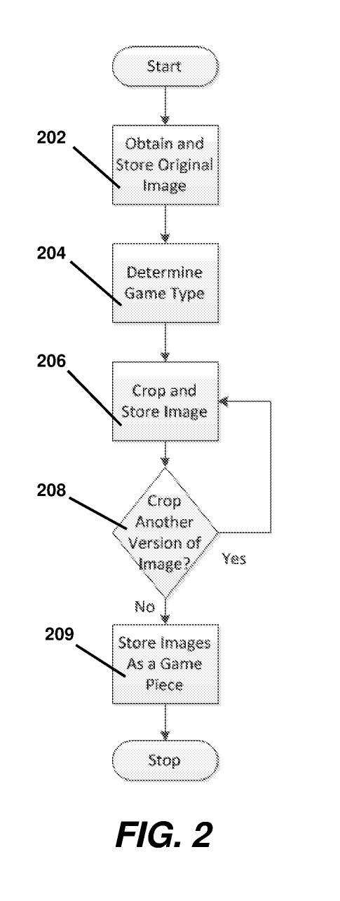

Referring to the flowchart of FIG. 2, embodiments of the invention may allow a user to obtain an image from a database or other source as described above. As is illustrated, using a computerized device 100, a user may obtain and store an image 202. Depending upon the embodiment of the invention, the images may be retrieved from a database 102 which is integral with the computerized device 100 or an image may be retrieved from an external database 103 in communication with the computerized device. One ordinarily skilled in the art will understand that, without limitation, one method of acquiring these images may do so through the use of a camera that is integral with the computerized device.

The user may determine the type of game in which the images may be used 204. Examples of different embodiments of such games may include, but are not limited to, a single player game, multiple player games in which a player competes against other players, games in which a player's opportunity to guess an image is limited by time, or games in which a player receives a points score that decreases as the player unsuccessfully attempts to guess the image.

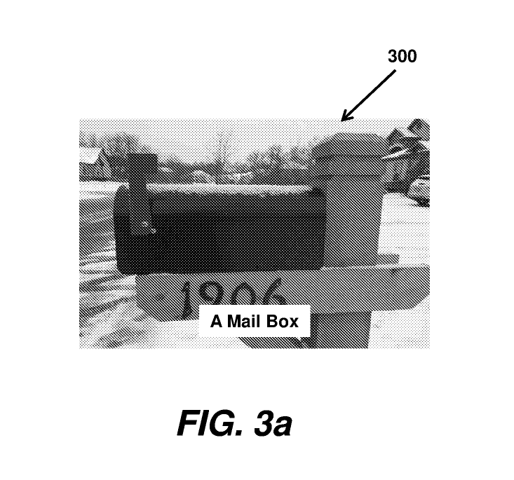

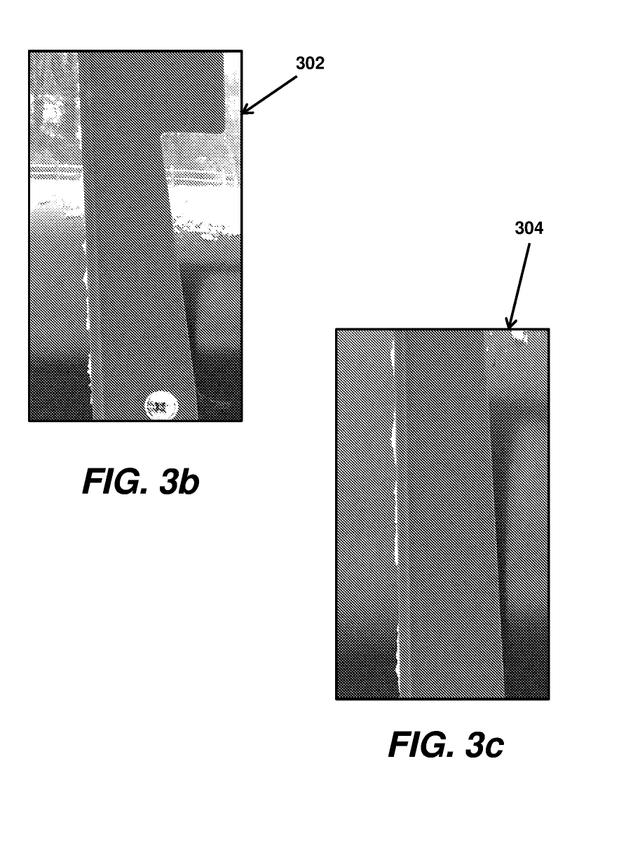

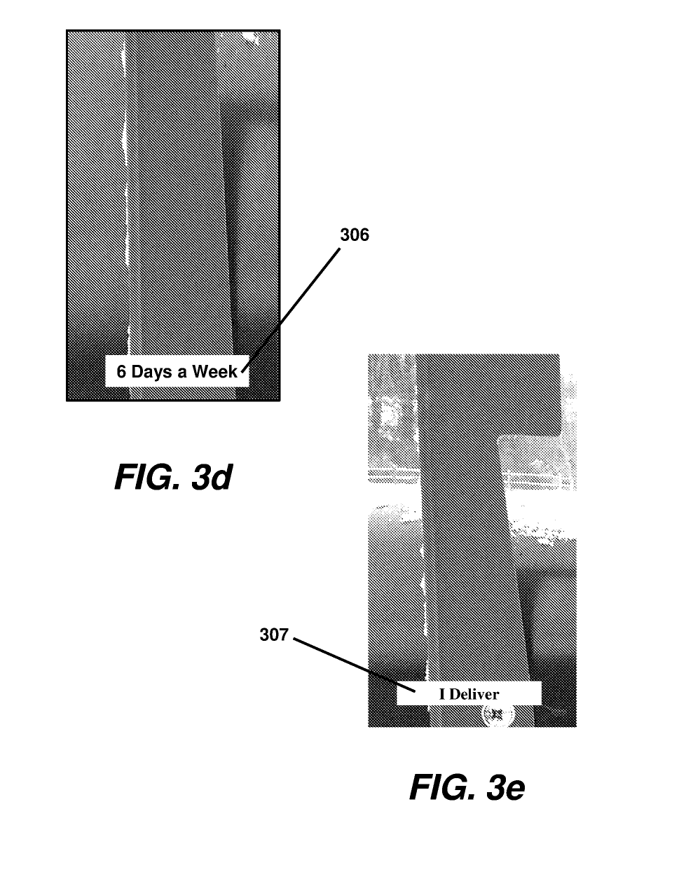

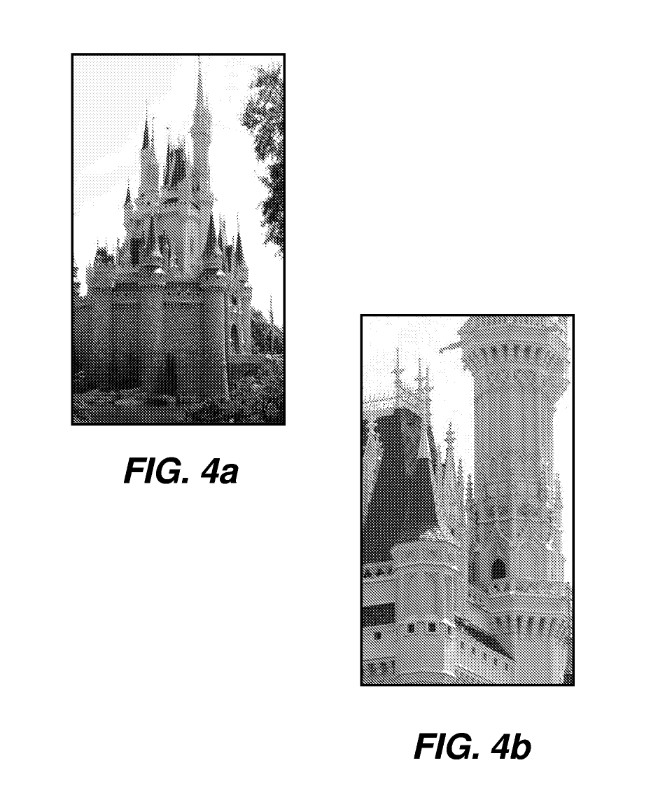

Using an input device 108 (for example, a touch screen), the user may adjust the size and position of the image viewing area 206 using, for example, a touch sensitive screen of a smart phone. For example, in an exemplary embodiment, a user may start with a full image 300 as illustrated in FIG. 3a. As described in flowchart steps 206 and 208, the user may wish to create a second image. This second image may comprise a smaller portion of the original image 302 as illustrated in FIG. 3b. If desired, the user may continue to crop the image, as illustrated in FIG. 3c at 304, until the user is satisfied with the number of images to be used to play the game. In some embodiments of the invention, the user may be prevented from cropping the image to such a small portion of the original image that the resultant resolution of the image renders it illegible. Another example is illustrated in FIGS. 4a and 4b. As shown, FIG. 4b is a cropped version of the image illustrated in FIG. 4a. As may be noted in FIG. 4b, in embodiments of the invention, a user may adjust the portion of the original image displayed in the cropped image. As is illustrated, the cropped image is not necessarily located at the center point of the original image.

### Game Piece Creation

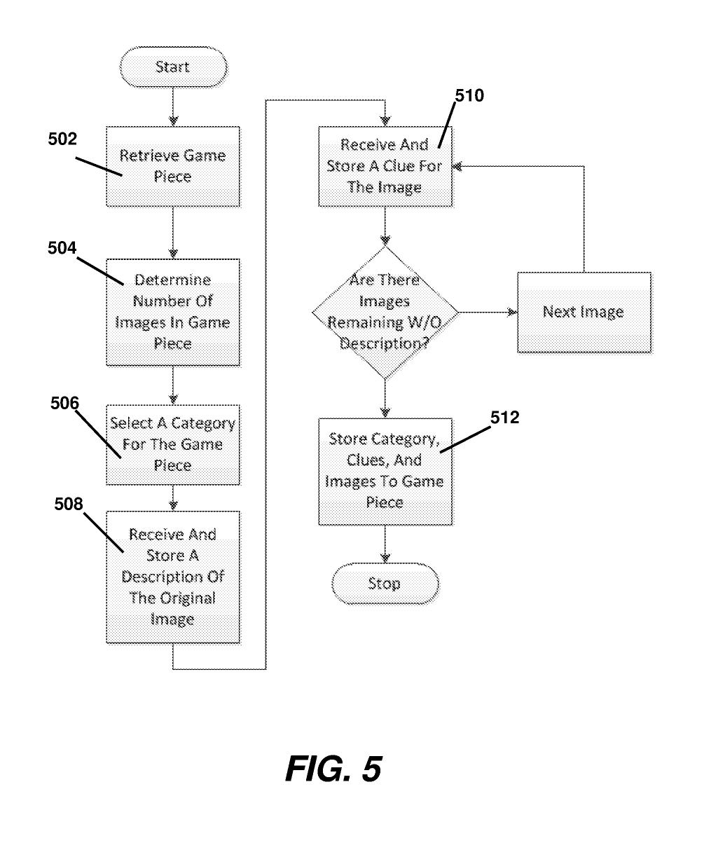

Once a user has stored an original image 202, and in certain embodiments of the invention, one or more cropped portions of the original image 206, the user may store those images into one or more game pieces 209. In such embodiments, a game piece may comprise a plurality of images and may include an original size image in addition to cropped images obtained from increasingly smaller portions than the original. Game pieces may also comprise information such as, but not limited to, clues to the subject of the various images, interesting background information regarding the image, and a category description that describes the topic of the image. As is illustrated in the flow chart of FIG. 5, to create a game piece, a user may retrieve an initial image 502. Depending upon the game and the desire of the user, additional cropped images may also be retrieved 504. In step 506, the user may select a category for the game piece. Example categories include, but are not limited to, “what”, “where”, “who”, “when”, and custom categories that may be entered by the user. Examples of custom categories may include, but are not limited to, “what am I doing?”, “don't you wish you were here?”, “name that body part”, and “what zoo animal is this?” The received category may be stored in a location that represents the game piece. In certain embodiments of the invention, a description of the original image may be received and stored in step 508. In order to assist a player, or to make the game more entertaining, a clue may be received for each image in step 510. As is illustrated at step 512, the various images, category description, and image clues may be stored in a location that represents a game piece. In an exemplary embodiment, the location may be a database or other computer storage device. This process may be repeated as desired by a user of the invention to create one or more game pieces that may be used to play embodiments of the inventive guessing game.

### Game Play

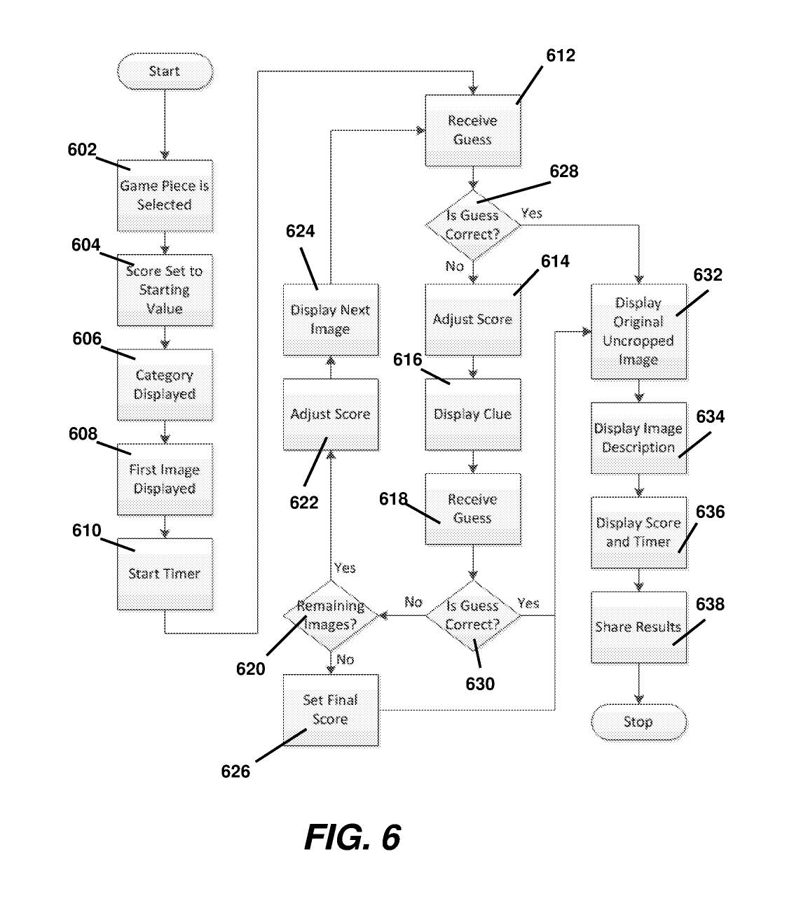

Once one or more game pieces have been created, one or more players may interact with embodiments of the invention to play guessing games using the game pieces. Embodiments of the invention may utilize approaches to determine the winning play through the use of a score, a time to guess correctly, or a combination of both. An exemplary embodiment of the steps involved in playing a version of the inventive game is illustrated in the flow chart of FIG. 6. A user or player may select a game piece in step 602 to be used in an embodiment of the game. In an example embodiment, a score may be set to a predefined maximum value for the game piece in step 604. To assist a player in their identification of the image, a category representing the game piece may be displayed to the player in step 606. When a player is ready, the first image may be displayed for that user to view 608. Certain embodiments of the invention may start a timer in step 610. Depending upon the embodiment of the invention and method of scoring the game, the timer may be used to limit the time that a player has to enter a guess. Other embodiments of the invention may determine a player's score by using the amount of time that has passed during game play. In such an embodiment, the faster a player enters his or her guess, the better the score which may be earned for a correct guess. Other embodiments may use a combination of both methods. After an image has been displayed, an embodiment of the invention may receive a guess from a player 612. In certain embodiments of the invention, a game piece may comprise images, clues, and categories needed to play the game. In such an embodiment, the player is not required to be in communication with the user or other players in order to play the game. The invention may check the received guess to determine if it is correct. If the guess is incorrect, the available score may be adjusted in step 614. In order to assist the player, a clue may be displayed 616. Example clues are illustrated in the images of FIGS. 3d at 306 and 3e at 307. As illustrated at 302 or 304, an image may be displayed without a clue. If a player guesses incorrectly or a timer expires, the same image 302 or 304 may be displayed with the addition of a clue as illustrated at 306 and 307. After the display of the clue, an embodiment of the invention may receive a guess from a player 618. If the guess is incorrect or a timer expires before the player enters the guess, an embodiment of the invention may determine if there are images remaining on the game piece 620. If there are remaining images, an embodiment of the invention may adjust the available score 622, display the next image 624, and receive a guess from a player 612. The process repeats until a correct guess is entered or there are no remaining images on the game piece. If there are no images remaining, the score may be set to its final value 626. As described above, game pieces may be created and stored in a database in electronic communication with or as part of a computerized device used to play the game embodied by the invention. Therefore, one ordinarily skilled in the art will understand that images associated with a game piece may be referred to as being “on” the game piece but actually be stored in one or more memory locations that are associated with a game piece that is represented by a set of memory locations.

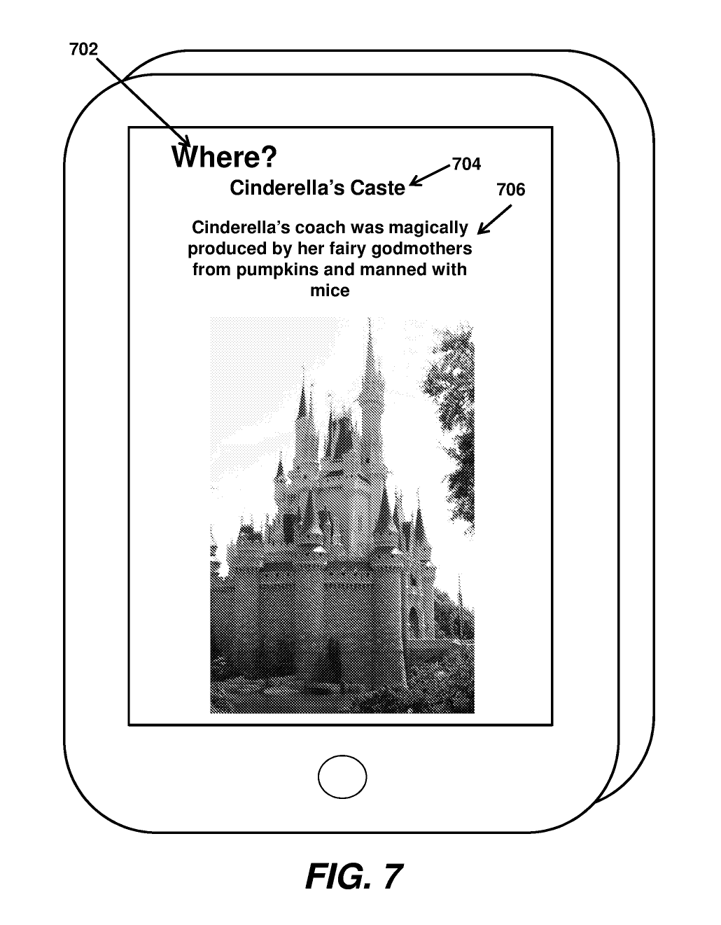

Once a player has correctly guessed the image (628 or 630), the original image may be displayed 632 to allow a player to confirm his or her guess or to understand what the images and clues were attempting to describe. A description may also be displayed 634. An example of such a display is illustrated in FIG. 7. As is illustrated, in an embodiment of the invention, a category may be displayed 702. A description of the image may comprise a simple description 704, or may include additional information 706 to help the player understand what is represented by the image or to further entertain or educate the player.

### Multi-Player Embodiments

Referring again to FIG. 6, embodiments of the invention may also display a player's score, amount of time calculated by the timer, or a combination thereof 636. Certain embodiments of the invention may be configured to allow a player to share their score with others 638. For example, embodiments of the invention may be configured to send a player's score, a value from a timer, game piece information, or a combination of these to a social media platform. In such an embodiment, sharing may allow a player to compare their game performance to others.

In certain embodiments of the invention, a plurality of players may be able to compete with one another. In an example of such an embodiment, a player may compete against one or more other players using the same game piece. In such an embodiment, a player may win the game by being the first to correctly guess the image. In another embodiment, a player with the least number of guesses may win. Other embodiments of the invention may enable players to compete against each other using different images. Examples of such embodiments may include a variation in which a player exchanges game pieces with another player he or she is competing against. The player with the best score or quickest guess (according to the method of scoring used to determine the winner) wins the game. Other embodiments may utilize game pieces selected or created by an administrator or other third-party source. Still other embodiments may be configured to allow one game player to play using a less difficult image than a player that they are competing against. Such embodiments may be particularly useful when an adult is playing the game with a child. For example, a child player may be provided an image that is less difficult than the image provided to an adult player. Such embodiments may allow each player to be challenged equally.

Referring again to FIG. 1, embodiments of the invention may use a single computerized 100 device to participate in the game. Other embodiments of the invention may be configured to use a plurality of computerized devices. An example of such an embodiment is illustrated by the computerized devices 112A and 112B. In such an embodiment, the computerized devices may communicate with each other using an electronic communication network 114. Embodiments of such a network may include, but are not limited to, wired computer networks, wireless computer networks, the internet, and cellular data networks.

Any embodiment of the present invention may include any of the optional or preferred features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention. It is the intention, therefore, to limit the invention only as indicated by the scope of the claims.

What is claimed is:

1. A computerized method of performing an image guessing game comprising the steps of:
creating a database;
adding at least one full image to the database;
adding at least one cropped image to the database for each of the at least one full images in the database wherein the cropped image comprises a portion of the full image;
adding at least one clue to the database associated with the at least one full image;
retrieving a cropped image from the database;
retrieving the clue associated with the retrieved cropped image from the database;
displaying the retrieved cropped image;
receiving an input from a user representing the user's guess as to the subject matter of the displayed image;
displaying an indication of the correctness of the received user's guess; and
displaying the retrieved clue in response to the receipt of the user's incorrect guess.

2. The method of claim 1 further comprising the steps of:
adding at least one category to the database associated with the at least one full image;
retrieving the category from the database; and
displaying the category.

3. The method of claim 2 wherein:
the categories are selected from a list comprising who, what, where, when, and a user defined category.

4. The method of claim 1 further comprising the steps of:
adding a score value to the database;
adjusting the score value based on the correctness of the user's guess; and
displaying the score value.

5. The method of claim 1 further comprising the steps of:
adding a time value to the database;
adjusting the time value; and
displaying the time value.

6. The method of claim 1 further comprising the steps of:
adding at least one additional cropped image to the database for each of the at least one cropped images wherein the cropped image comprises a portion of the full image; and
displaying the at least one additional cropped image in response to the receipt of the user's additional incorrect guess.

7. The method of claim 4 further comprising the steps of:
adding a final score to the database;
transmitting the final score to a networked database; and
displaying the final score.

8. The method of claim 4 further comprising the steps of:
adding a final score to the database;
displaying the final score;
transmitting the final score to a networked database on a second user's electronic device;
receiving a second user's final score from the networked database;
displaying winner information on the display based on a determination of which user has the highest final score.

9. The method of claim 8 wherein:
the final score is the score value after the user input has been received for all of the displayed images.

10. The method of claim 1 further comprising the steps of:
retrieving a full image from the database; and
displaying the retrieved full image.

11. The method of claim 7 further comprising the steps of:
exchanging the full images, the cropped images, and the clues stored in the database with at least one full image, at least one cropped image, and at least one clue stored in the networked database.

12. The method of claim 11 wherein:
the displayed image is the at least one cropped image received from the networked database.

13. A system for performing an image guessing game comprising:
a first electronic device comprising a database, a display, a processor, software instructions, and an input device;
wherein the database of the first electronic devices comprises at least one full image, at least one cropped image which comprises a portion of the at least one full image, at least one clue, and a score value; and
wherein the software instructions of the first electronic device, when executed by the processor of the first electronic device perform the steps of:
retrieving the at least one cropped image from the database of the first device;
displaying the retrieved at least one cropped image on the display of the first device;
accepting input from a user regarding the content of the at least one cropped image by way of the input device of the first electronic device;
determining the correctness of the input by way of the processor of the first device; and
adjusting the score value based on the correctness of the input.

14. The system of claim 13 wherein:
the first electronic device further comprises a communications interface configured to allow electronic communication with an electronic network.

15. The system of claim 14 wherein:
the software instructions when executed by the processor of the first electronic device perform the step of transmitting the score value to the electronic network using the communications interface.

16. The system of claim 15 further comprising:
a second electronic device itself comprising: a database, a display, a processor, a set of software instructions, an input device, and a communications interface wherein the database of the second electronic device comprises a second score value.

17. The system of claim 16 wherein:
the software instructions of the second electronic device configure the communications device of the second electronic device to receive the score value of the first electronic device from the electronic network; and
the software instructions of the second electronic device, when executed by the processor of the second electronic device cause the processor to transmit the second score value to the first electronic device using the electronic network.

18. The system of claim 16 wherein:
the database of the second electronic device further comprises at least one full image, at least one cropped image which is comprised of a portion of the at least one full image, and at least one clue associated with the at least one full image;
the software instructions of the second electronic device when executed by the processor of the second electronic device causes certain images stored in the database of the second electronic device to be transmitted to the database of the first electronic device;
the software of the first electronic device, when executed by the processor of the first electronic device causes the first electronic device to retrieve the transmitted images from the database of the first device and display those images on the display of the first electronic device; and
the software of the first electronic device, when executed by the processor of the first electronic device, causes certain images stored in the database of the first electronic device to be transmitted to the database of the second electronic device; and
the software of the second electronic device when executed by the processor of the second electronic device causes the second electronic device to retrieve the transmitted images from the database of the second device and display those images on the display of the second electronic device.

19. A computerized method of performing an image guessing game comprising the steps of:
providing a portable electronic device comprising a storage device, a display, a processor, and an input mechanism;
creating a database on the storage device, said database comprising at least one full image, at least one cropped image which is comprised of a portion of the at least one full image, at least one clue associated with the at least one full image, at least one category associated with the at least one full image, and a score value;
retrieving the at least one cropped image from the storage device;
retrieving the category associated with the displayed image from the database;
displaying the retrieved cropped image on the display;
displaying the retrieved category on the display;
accepting input from a user regarding the content of the cropped image by way of the input mechanism;
determining the correctness of the input by way of the processor;
adjusting the score value based on the correctness of the input;
retrieving the clue associated with the displayed image from the database;
displaying the retrieved clue on the display in response to receipt of the user's incorrect guess; and
displaying the full image on the display.

20. The method of claim 19 wherein:
the categories are selected from a list comprising: who, what, where, when, and a user defined category.
